(19) United States
(12) Patent Application Publication
(10) Pub. No.: US 2003/0014407 A1
(43) Pub. Date: Jan. 16, 2003

(54) System and method for making media recommendations

(75) Inventors: Steven G. Blatter, New York, NY (US); David Brown, San Francisco, CA (US)

Correspondence Address: FOLEY AND LARDNER, SUITE 500, 3000 K STREET NW, WASHINGTON, DC, 20007, US

(73) Assignee: Green Arrow Media, Inc.

(21) Appl. No.: 10/119,905

(22) Filed: Apr. 11, 2002

Related U.S. Application Data
(60) Provisional application No. 60/282,885, filed on Apr. 11, 2001.

(51) Int. Cl. G06F 7/00; G06F 17/30

(52) U.S. Cl. 707/6

(57) ABSTRACT

A system and method generates a recommendation to a user for a media object from a plurality of media objects located in a media object database stored in a memory. Each media object includes a plurality of properties, each property having one or more values. The plurality of media objects are filtered into a filtered pool of media objects based on a user profile corresponding to the user. A plurality of target property values are selected based on the user profile, and a score is generated for each of the media objects in the filtered pool based on the selected target property values. A media object is recommended to the user from the media objects in the filtered pool based on the scores generated for each of the media objects in the filtered pool.

### RELATED APPLICATIONS

This application claims priority to Provisional Application Serial No. 60/282,885, filed on Apr. 11, 2001 under 35 U.S.C. §119(e). The content of the Provisional Application Serial No. 60/282,885 is hereby incorporated by reference.

### FIELD OF THE INVENTION

The present invention relates generally to making media recommendations to users, and more particularly to a system and method for making media recommendations based on user profile data in conjunction with expert human knowledge and artificial intelligence.

### BACKGROUND OF THE INVENTION

Consumers have a vast selection of content available for their consumption through a wide array of media outlets. The average American home today has 2.9 TV sets, 1.8 VCRs, 3.1 radios, 2.6 tape players, 2.1 CD players, 1.4 video game players and 1 computer. The proliferation of media and the endless supply of entertainment content available make it difficult for consumers to effectively and efficiently identify content that fits their tastes. In addition, the increased usage of downloaded media via the Internet decreases outside influences and pathways, which makes it difficult for consumers to learn about additional media. Also, certain forms of media are consumed passively, such as a radio stations played in the background. This passive consumption makes it difficult for consumers to recall particular pieces of content that they like or dislike. Consumers also have varying definitions of particular qualities of content. For example, certain consumers would classify Shania Twain's music as country, while others would classify her music as pop.

A solution to assisting consumers in identifying entertainment content that fits their tastes is to elicit their preferences via a computer network and then recommend content to them based on their preferences. Existing methods for recommending content to consumers are ineffective. For example, they lack the proper user profile data to accurately and consistently recommend content that meets a consumer's tastes. In addition, some recommendation methods also require knowledge beyond the average consumer and/or require a broadband Internet connection that severely limits their adoption. Still other systems are reliant on Digital Signal Processing (DSP) technology. DSP, however, is very ineffective in finding songs which “sound similar” to a given song because it can only match simple music characteristics, such as tempo, rhythm, and instrumentation. Human perception of musical similarity is a far more complex combination of many inputs, some of which are still unknown.

An example of an inadequate content recommendation system is Music Buddah (Mubu). Mubu is a song recommendation system, where users first select a favorite genre of music and are then asked to rate a selection of audio clips. The system relies on incomplete user profile data (lacking demographic, geographic and psychographic data on each user) to recommend music to the user.

The Mubu system is reliant on a user's selection of their favorite genre of music. This process is inadequate because all consumers have varying definitions of different music genres. For example, certain consumers would define “alternative rock” as music from newer artists like Limp Bizkit, Linkin Park and Kid Rock, while other consumers would define “alternative rock” as music from older artists like The Cure, Depeche Mode, and New Order. The Mubu system also presents users with confusing and unknown genre classifications, such as “Working Class,” “Detention” and “Tattoos & Poolcues.” This makes it difficult for users to identify their preferences accurately. Another feature of the Mubu system is to recommend songs after the user hears a short series of song clips one time. Research has shown that it is difficult to elicit a user's music preferences based on their responses to hearing only a few song clips. To accurately measure a user's music preferences one must have them rate at least 30 song clips, a process that is too long given current technology limitations. Finally, the Mubu system works best with a high-speed Internet connection, since it requires audio clip downloading. Most Internet users still use relatively slow dialup connections, which means they will require extended periods of time to complete the Mubu process.

In another Internet based song recommendation system, called Mongomusic, users can input the name of a song, artist, or album and be recommended similar songs, artists, or albums. This system relies on matching songs and artists with similar properties. However, it suffers from users' inconsistent classification of song and artist properties. This problem can only be avoided if a user was a music enthusiast or expert and was able to name a significant number of his/her favorite songs or artists. Mongomusic also uses digital signal processing to recommend music, which gives recommendations that are often incompatible with the user's tastes.

Moodlogic, another Internet based system, allows users to express their preferences for genre, mood, decade, tempo, beat, popularity, lead vocals, vocal style, and instrument. Like Mubu, Moodlogic relies on users to name a favorite genre of music, for which consumers have inconsistent definitions. In addition, Moodlogic uses song and artist data collected from non-professional sources (i.e. users of the internet). However, most users do not have enough knowledge to accurately classify song data, resulting in a high probability of inaccurate or inconsistent song and artist data used in recommendations.

Amazon.com is yet another Internet based system that uses collaborative filtering to recommend music to users. The premise behind their system is that a user will have similar musical tastes to others with whom they share common purchases. Collaborative systems such as Amazon's are often swayed into recommending items which are tangential to the user's tastes. This “off the mark” effect is usually due to a large group of people whose tastes are generally not the same as the user's, except in a small overlapping area. Another pitfall of Amazon's system is an inability to recognize purchased items as not being representative of the purchaser. Gifts bought for others may incorrectly “trick” the collaborative system into misrepresenting a user's tastes. Lastly, while purchases are a good indication of a user's tastes, there is no way in Amazon's system to explore a person's preferences in areas which they have not made a prior purchase. Consumers often like music which they do not buy, and this preference data is not captured by collaborative filtering.

Other Internet based recommendation systems suffer from some combination of drawbacks associated with Mubu, Mongomusic, Moodlogic, and Amazon. These other systems currently include Gigabeat and MusicMatch.

### SUMMARY OF THE INVENTION

Briefly, in one aspect of the invention, a method for generating a recommendation to a user for a media object from a plurality of media objects located in a media object database stored in a memory, wherein each media object includes a plurality of properties, each property having one or more values, includes filtering the plurality of media objects into a filtered pool of media objects based on a user profile corresponding to the user. A plurality of target property values are selected based on the user profile, and a score is generated for each of the media objects in the filtered pool based on the selected target property values. A media object is recommended to the user from the media objects in the filtered pool based on the scores generated for each of the media objects in the filtered pool.

In another aspect of the invention, the user profile is modified based on the media object recommended to the user. The user profile may include a preference value for each of the plurality of property values of the recommended media object such that each preference value of the user profile is adjusted based on each of the plurality of property values of the recommended media object.

### BRIEF DESCRIPTION OF THE DRAWINGS

FIG. 1 is a block diagram of a computer network consistent with the present invention.

FIG. 2 is a flow diagram for making media recommendations consistent with the present invention.

FIG. 3 is a flow diagram for filtering media objects consistent with the present invention.

FIG. 4 is a flow diagram for picking target property values consistent with the present invention.

FIG. 5 is a flow diagram for scoring media objects consistent with the present invention.

FIG. 6 is a flow diagram for choosing media objects to recommend consistent with the present invention.

FIG. 7 is a flow diagram for modifying a user profile consistent with the present invention.

### DETAILED DESCRIPTION OF THE PREFERRED EMBODIMENT

To consistently recommend content that satisfies a consumer's tastes, it is preferable to obtain profile and preference data that incorporates demographic, geographic, and psychographic data about the user. Psychographics are characteristics of consumers which, rather than purely demographic data, measure a user's attitudes, interests, opinions, and lifestyles. Without a user's demographic, geographic and psychographic profile, it is difficult to consistently generate accurate content recommendations.

Consistent with the present invention, a system for determining a user's media or content preferences uses demographic, geographic and psychographic profiles of the user. The user's media preferences relate to the user's interest for any type of content including songs, albums, music videos, movies, radio stations, TV stations, TV shows, books, video games and the like. The system uses two databases, a media object database and a user profile database. The media object database includes a series of media objects, where each media object contains data reflecting the object's properties for this particular medium or content. Objects may have more than one value for a particular property. Data for this database may be obtained from published sources and/or entered manually by experts in the particular area of media. The system may be implemented as a server computer accessible via the Internet or other network.

The information in the media object database includes the following. A media type is a general format of the media, such as “song,” “radio stations,” “albums,” “music videos,” “movies,” “radio stations,” “TV stations,” “TV shows,” “books” and “video games.” A media object is an instance of a media type stored in the database. Examples of media objects include: “Radio station: WXRK;” and “Song: Aero smith—Dude Looks Like a Lady.” A media property is one of a set of characteristics of a media type. Each media object possesses values for the media properties of the media type. For example, media properties for songs may include category (combination of familiarity and popularity), sub-genre, soundcode, tempo, regional appeal, and any other characteristics of a song. A media property value is the actual data for a media property. Each media object is described by its media property values. For example, for the song “Aerosmith—Dude Looks Like A Lady,” the media property values may be category: R, sub-genre: HardRock, and Tempo: Medium. A media outlet is a source of media objects available to consumers. For example, a radio station is a media outlet for songs.

Below are examples of a layout in the media object database for two different media types:

[media type: songs] media object=song; media properties=tempo, mood, era, format, sub-genre, gender, ‘sound_code’, ‘category’, regional appeal, along with geographic locations where the song is played.

[media type: radio stations] media object=station; media properties=call letters, dial position, geographic location, format, “sub_format,” time zone, “music_quality,” era.

The media object database is dynamic. It may be updated to reflect changes in the properties of media objects due to external influences, such as national or local fads. A media object may be updated when any of its properties change. For example, in the database of media objects, a media object for a song may be updated if the popularity of the song changes, other radio stations begin playing the song (possibly changing its sub_genre or sound_code), or as the song becomes part of a new era of music due to the passage of time.

To generate the user profile database, the following three databases may be used. The first one is a database of modular questions. Each question in this database may be associated with one or more demographic, geographic, or psychographic properties of the user, such as location, media type, gender, and age. Additionally, each question may be associated with a set of impact rules which describe how to modify a user's profile to reflect their answer to the question.

A second database is a database of “media outlets.” A media outlet is a source of “media objects” available to consumers. Each media outlet in the database contains data describing some media properties of all media objects served through this outlet. This database may be a subset of the media object database described above. An example of the layout of the database of media outlets is shown below:

[media type: songs] media outlet=traditional offline radio station; outlet data=songformat (i.e. classic_rock, country, hip-hop).

The third database is a database of zip codes and associated city names.

Using these databases, the process for profiling a user first determines the user's geographic location, gender, age and preferred media outlet. This determination may be accomplished by a data-entry page on a website. Users who do not have a preferred media outlet may instead enter their choice of media properties to use in subsequent steps.

In the database of user profiles, each profile includes information about a user's preferences for various media properties of a particular media type. Preferences may be represented on a scale of 0 to 100, with 100 being the maximum preference. To obtain a user's preferences, users can be asked questions aimed at obtaining their preference information via inference and highly correlated non-musical tastes. This level of indirection allows the system to avoid asking highly specific questions about media, such as music, which most users would be unable to answer properly or correctly. Profile data can thereby be obtained from a user's answers to a set of questions. These profile questions may pertain directly to the user's media use, such as music listening habits and other likes. The profile questions may also ask questions indirectly related to the user's media use or interests in particular media types. Nevertheless, it is possible to ascertain a user's media preferences from such indirectly related questions. For example, it is possible to determine some aspects of a user's media preferences based on the type of clothing worn by the user, such as shown below in the exemplary profile questions.

Profile questions, which are preferably closed-ended, modular, and easy-to-answer, can provide information about the media preferences of a user. Questions may be categorized based on the type of information they can elicit (such as tempo preferences, genre preferences, etc. . . . ).

The questions presented measure each user's preferences for tempo, era, mood, gender, repetition, genre, and other criteria applicable to that medium. The potential questions are ranked based on the amount and type of user profile information they provide. Each profile question is associated with one or more preferences in the user profile. (e.g. a question may affect the ‘tempo’ preference in the profile). Users may be presented with profile questions in a ranked order. For each question the user answers, the value for the question's associated preference(s) in the user's profile is refined. The final user profile reflects each user's unique preferences. The final user profile may be normalized so that the preferences for each media property sum to 100 while maintaining their original mathematical ratio to one another, and then stored in a database that can be referred to each time the user subsequently logs on to the web site. Examples of profile questions and their impacts on the user's profile preferences are given below:

Question: The brand of clothing I like the most is:
a) GAP
b) Fubu
c) Billabong
d) Diesel
e) None of the major brands
f) None of the above
User Profile Impacts:
a) Sub-genre: PUNK * 0.5
b) Sub-genre: HIPHOP = MAX (20, HIPHOP * 2)
c) Sub-genre: PUNK * 2
d) Sub-genre: TECHNO * 10
e) Sub-genre: FOLK * 5
f) No impact
Question: When my favorite songs start getting played on every radio
station in [user's city]:
a) those songs are no longer cool to me
b) it doesn't really bother me
User Profile Impacts:
a) Sound-code: POP = 0
b) Sound-code: POP = 30, DONT_CARE = 70
Question: 80's music from artists like [Talking Heads, The Clash, and
The Police]*:
a) totally rules!
b) only in small doses
c) a complete waste of time
d) not familiar with these artists
* The artists listed depend on the user's geographic location.
* For West Coast or Midwest users, the artists are Talking Heads, The
Clash, and The Police.
* For East Coast users, the artists are Cure, Depeche Mode, and New
Order.
User Profile Impacts:
a) Category: I * 8
b) Category: H * 0.75
c) Category: I = 0
d) Category: I = 0
Question: The magazine that I like the most is:
a) Rolling Stone / Spin
b) The Source
c) People / Teen People
d) None of the above
User Profile Impacts:
a) SubFormat: ALTERNATIVE + 25, MAINSTREAM + 10
b) SubFormat: HIPHOP + 25
c) if (question 1 (‘c’ or ‘d’,)) then
SubFormat: TEENYBOPPER + 25
else
SubFormat. MAINSTREAM + 25
d) No impact
Question: I watch TRL with Carson Daly on MTV:
a) Frequently, Carson rulez!
b) Occasionally
c) Never, Carson sux!
d) What's TRL?
User Profile Impacts:
a) SubFormat: TEENYBOPPER + 25
b) SubFormat: TEENYBOPPER + 5
c) SubFormat: ALTERNATIVE + 10; TEENYBOPPER = 0
d) No impact
Question: I first started listening to hip hop and R&B in the:
a) 80's
b) early 90's
c) late 90's
d) last few years
User Profile Impacts:
a) SubFormat: OLDSCHOOL + 10, URBANAC + 10
b) SubFormat: OLDSCHOOL + 5, URBANAC + 5
c) SubFormat: HIPHOP + 5
d) SubFormat: HIPHOP + 10
Question: When I was in high school, I wore:
a) Black concert tees
b) Tie dye T-shirts
c) Alligator shirts
d) None of the above
User Profile Impacts:
a) SubFormat: HARDROCK + 10
b) SubFormat: GRATEFULDEAD + 10
c) SubFormat: MAINSTREAM + 10, CORPROCK + 10
d) No impact
Question: There hasn't been any really good rock music since the
late 70's:
a) strongly agree
b) somewhat agree
c) disagree
User Profile Impacts:
a) Era: SIXTIES + 15, SEVENTIES + 15
b) Era: SIXTIES + 10, SEVENTIES + 10
c) Era: SIXTIES + 5, SEVENTIES + 5, EIGHTIES + 15, NINETIES + 5

In addition to the user's preferences, each user profile may contain a list of the most recent media objects recommended to that user, referred to as a user's history. Below is an example of the layout of the user profile database for one media type:

[media type: songs] user profile data=preferences for tempo, mood, era, format, sub-genre, gender, ‘sound-code’, ‘category’, regional appeal, geographic location.

A list of profile questions is then provided to the user. Using the information just gathered from the user, profile questions are selected based upon a match between their associated media properties, and the properties of the user just gathered. The responses to each profile question are used to build a profile on the user. Starting with a blank or default profile, the profile is affected according to the impact rules associated with the question's response.

A user profile contains information about a user's preferences for each property of a particular medium. Table I below is an example of a user profile for songs.

TABLE 1

| Property | Property Value | Percentage (preference) |
|---|---|---|
| Category | A | 20 |
| | B | 0 |
| | C | 0 |
| | R | 40 |
| | G | 25 |
| | H | 10 |
| | I | 5 |
| SubGenre | HardRock | 30 |
| | PunkRock | 20 |
| | GrungeRock | 15 |
| | Mainstream | 35 |
| SoundCode | Wimpy | 20 |
| | Medium | 10 |
| | Strong | 70 |

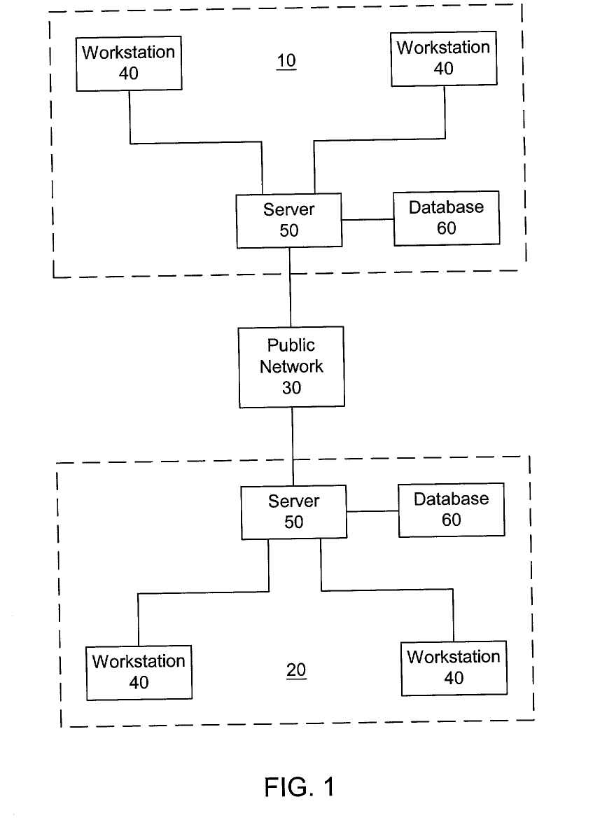

FIG. 1 is a block diagram of a computer network consistent with the present invention. As shown in FIG. 1, local networks 10 and 20 are each connected to a public network 30. Local networks 10 and 20 each include a plurality of workstations 40, a server 50, and a database 60.

Each workstation 40 may include a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

A communication interface provides a two-way data communication coupling via a network link to the networks 10 and 20 and the public network 30. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the networks 10 and 20 and the public network 30. The networks 10 and 20 may be implemented, for example, as a LAN. The public network 30 may be implemented, for example, as the Internet.

Each server 50, like the workstations 40, may include a CPU, a main memory, a ROM, a storage device and a communication interface all coupled together via a bus. The databases 60 may be implemented as non-volatile storage that may be incorporated into the servers 50 or may be outside of the servers 50. The databases 60 may be implemented in a single storage device or in a plurality of storage devices located in a single location or distributed across multiple locations. The databases 60 store information, including information for the media object and user profile databases described above, and are accessible to the servers 50 and the workstations 40, in both networks 10 and 20. The information stored in the databases 60 may be stored in one or more formats that are applicable to one or more software applications that are used by the workstations 40 and servers 50.

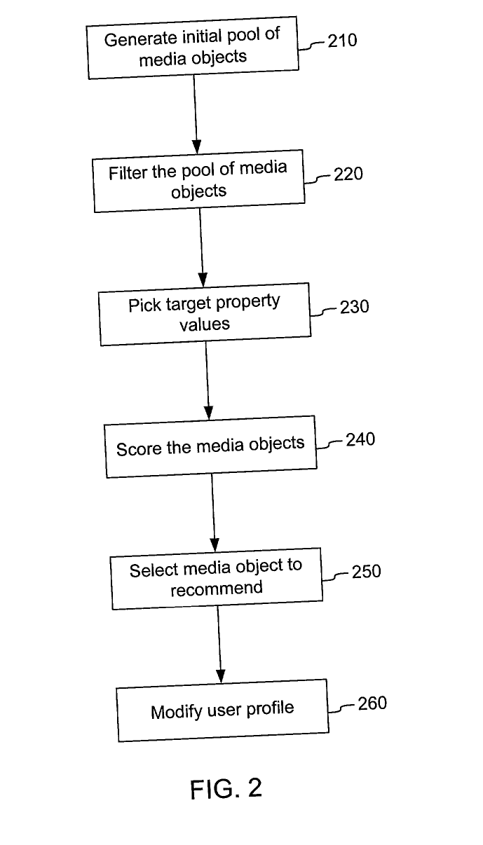

FIG. 2 is a flow diagram for making media recommendations consistent with the present invention. As shown in FIG. 2, an initial pool of media objects is generated from the media object database (step 210). The media objects chosen may be for a particular type of media, such as songs or movies. The type may be designated by the user seeking the media recommendation. The pool of media objects may be assigned dynamically to each unique user based on a match between the profile of that user from the user profile database and the media objects database classified according to these media properties. Media objects that are owned by the user, such as ones on their computer hard drive, may be removed from the pool.

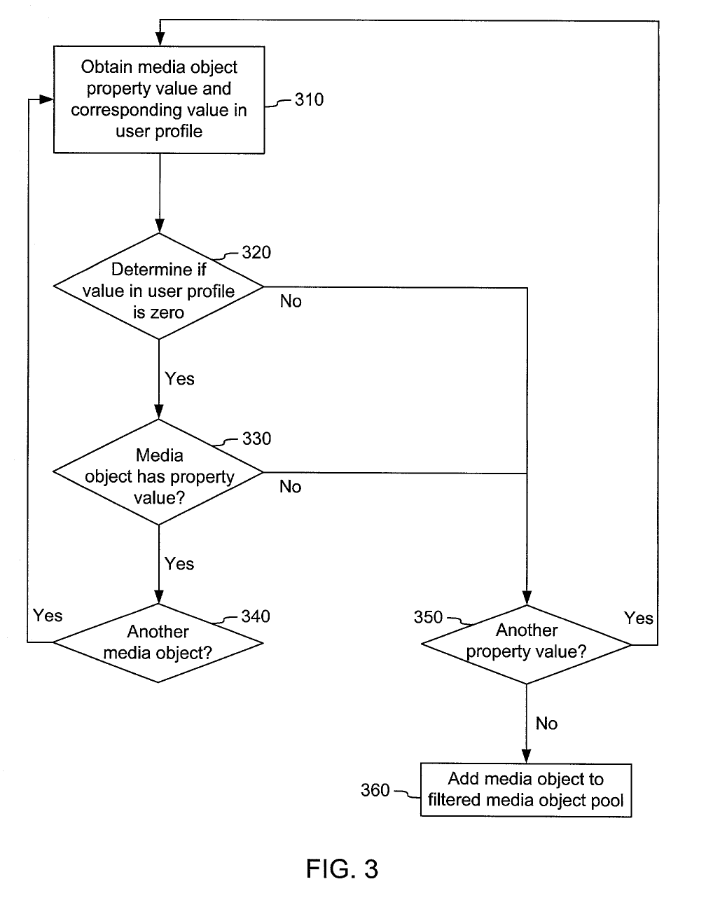

The pool of media objects is then filtered (step 220). The filtering is done with reference to the user profile of the user seeking the media recommendation. FIG. 3 is a flow diagram for filtering media objects consistent with the present invention. As shown in FIG. 3, a looping process to filter each of the media objects in the pool is performed. In the looping process, a property value of a media object and the corresponding value in the user profile are obtained (step 310). First, it is determined if a percentage value corresponding to a media property value in the user profile has a value of zero (step 320). This percentage value can be referred to as a preference value that may be represented as a percentage or some other type of measurement that reflects a users preference for a media property value. If the percentage or preference value is zero, it is then checked whether the media object has that media property value (step 330). If it does, the process is repeated for the next media object, if any (step 340), which effectively filters that media object from the pool. If the percentage value in the user profile is greater than zero or the current media object does not have the applicable media property value, the next property value of the media object is evaluated (step 350). If no percentage value in the user profile is greater than zero or the current media object does not have any corresponding media property value for zero values in the user profile, then the media object is added to the filtered media object pool (step 36).

In the filtering process of FIG. 3, media objects are removed that have property values for properties that the user does not want, i.e., has a zero percentage value for that property. For example, if a user has a zero percentage value for techno music and twenty percent for punk rock, the song “Alien” in the sub-genre “punk rock” would be kept in the pool, and the song “Play” in the sub-genre “techno” would be filtered from the pool.

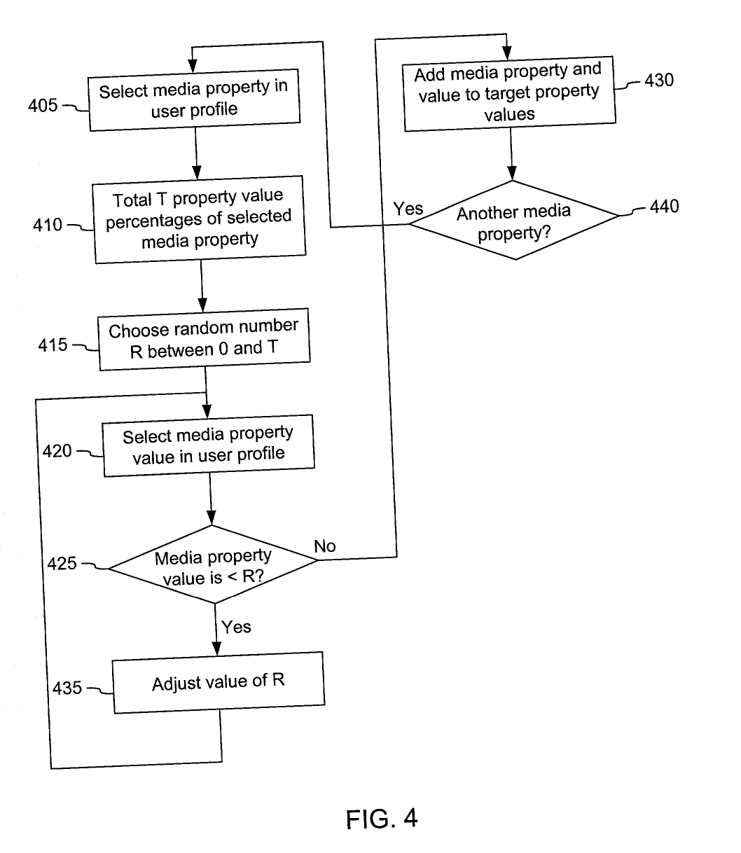

Returning to FIG. 2, after the media object pool is filtered, target property values are picked (step 230). Target property values represent property values that may be used as scoring criteria to determine which media objects to recommend and may be chosen based on the user's profile. FIG. 4 is a flow diagram for picking target property values consistent with the present invention. As shown in FIG. 4, the selection of the target property values loops through each media property in the user profile (step 405). For each media property, the total T of the percentages of the values in the user profile is calculated (step 410). This total T would typically be 100%, such as shown for the media properties category, sub-genre and soundcode in Table I. Then, a random number R is chosen between 0 and T (step 415). R may be determined by a computer's random number generator function.

After making these calculations, a media property value of one of the media properties is selected (step 420). For example, if the media property is sub-genre, the media property value may be hard rock. The percentage associated with the media property value is then compared to the value R (step 425). If the percentage associated with the media property value is greater than or equal to R, then the media property value is selected as a target property value (step 430). With reference to Table I, if R is 20% and it is compared to the value for hard rock, which is 30%, then hard rock would be selected as a target property value.

However, if the percentage associated with the media property value is less than the value R, then the value R is adjusted (step 435). For example, the value for R may be reduced by a percentage corresponding to the percentage associated with the media property value that had been less than R. With reference to Table I, if the value of R is 40%, then after comparing it to the 30% value for hard rock, the value of R would be reduced to 10%. This lower value for R is then compared to the next media property value, which is punk rock having a value of 20%. Since the 20% is greater than the 10% value for R, punk rock would be selected as the target property value. This process is then repeated for the next media property (step 440).

The process of using the random value of R to select the target property values for the different media properties can be further explained using the analogy of a bar graph. Each percentage associated with the media property values of a particular media property can be shown as a representative portion of a single bar in the graph, the single bar rising to the value T corresponding to the total percentage. This bar would then be compared to a bar representing the value of R. The portion of the bar for the media property values that intersects with the top of the bar for the value R is identified. The media property value corresponding to the identified portion would be selected as the target property value. Since R is selected randomly, the order in which the percentages associated with the media property values of the particular media property are arranged in the bar is irrelevant.

Having picked the target property values, the media objects are then scored (step 240 of FIG. 2). The media objects in the pool may be scored based on a match between the target values and the property values of each media object. The media objects are preferably sorted in descending order based on their score. The highest scoring media object which does not violate any rules, as described below, is then chosen as a recommendation for the user. The user's profile preferences are reduced to reflect the media which was recommended.

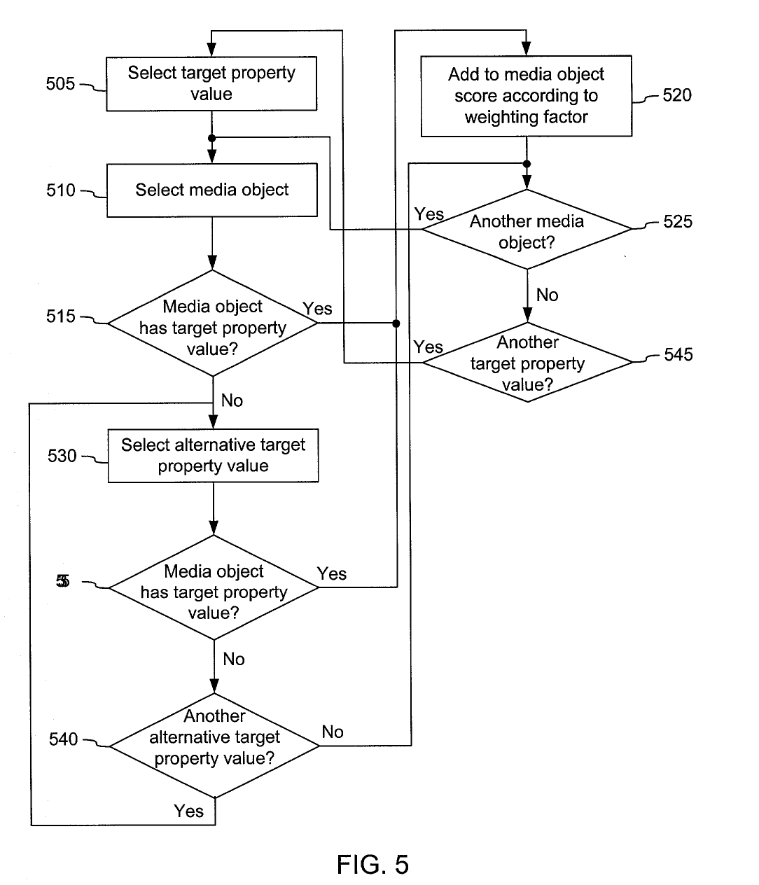

FIG. 5 is a flow diagram for scoring media objects consistent with the present invention. As shown in FIG. 5, a target property value is selected (step 505), and a media object is selected (step 510). The target property value is selected from the group of target property values picked according to the process of FIG. 4. The media object is selected from the pool of media objects filtered according to the process of FIG. 3. For the selected media object, it is determined whether it has the selected target property value (step 515). If it does, a score is added to the total score for that media object (step 520). The score is calculated according to a weighting factor for the selected target property. For example, if the sub-genre is an important media property for the user, than the sub-genre may have a relatively high weighting as compared to other media properties. This process is repeated for the remaining media objects in the filtered media object pool (step 525).

If the selected media object does not have the selected target property value, one of the other property values is used for the target property (step 530). For example, if the target property value was hard rock, one of the other property values, such as punk rock, would be used. The order in which one of the other target property values is used may be effected according to the relevance of a different property value to the target property value. It is then checked if the selected media object has the other property value (step 535). If so, a score is added to the total score for that media object (step 520). The score that is added is altered according to the position of the other property value in the ordered list. For example, if the other property value is the second in the list, the weighting factor may be divided by three, i.e. two plus the target property value. If the selected media object does not have the other property value, it is checked if there is another alternative target property value (step 540). If so, steps 530 and 535 are repeated. The ordered list is looped through until a match is found or there are no more entries in the list. This whole process is then repeated for each target property value (step 545).

As shown in FIG. 2, with the scoring for each media object in the filtered pool completed, the scores may be sorted in descending order. Tie scores may be broken randomly. Alternatively, the user may designate tie breaking rules, such as which media object had the higher score for a particular target property.

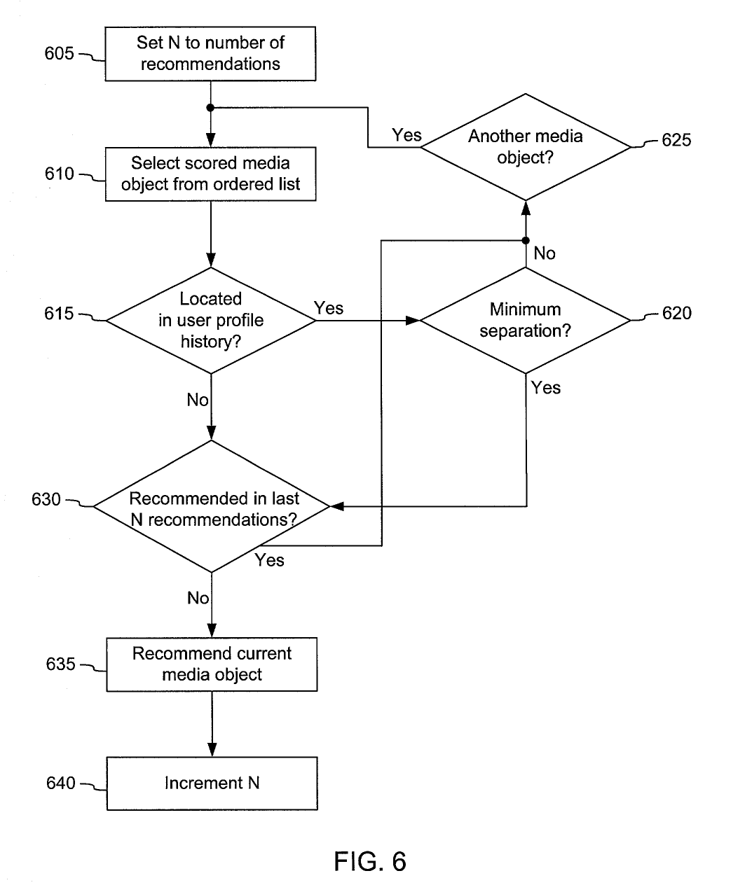

After placing the scored media objects in order, a media object is chosen to recommend to the user (step 250). FIG. 6 is a flow diagram for choosing media objects to recommend consistent with the present invention. As shown in FIG. 6, a number N is generated, which corresponds to the number of recommendations already given (step 605). Then, a scored media object is selected from the ordered list (step 610). If the scored media objects are ordered in descending order according to score, then the first one selected would be the media object with the highest score.

With reference to the user profile, it is determined whether or not the selected media object is located in the user profile history (step 615). The user profile history includes information about which media object have previously been recommended as well as the types and properties associated with those recommended media objects. If the selected media object is located in the user profile history, then separation rules are checked (step 620).

There are several rules that may be applied to limit the way a media object is recommended. The first of these rules is a minimum separation rule. According to this rule, the same media object may not occur more than once within any given set of N objects recommended to the user, where N is an integer. According to a property separation rule, any two media objects with a specific media property X may not occur more than once within any given set of N objects recommended to the user. Below is an example of a property separation rule.

[media type: songs] Example: Two songs with the same sub-genre may not occur within 5 songs of each other.

If the location in the user profile history is not greater than the minimum separation according to the rule, the selected media object is not recommended and the next media object, if any, is selected and checked according to the same rules (step 625). On the other hand, if the selected media object is not in the user profile history, or the location in the user profile history is greater than the minimum separation according to the rule, it is determined whether the selected media object has already been recommended in the last N recommendations (step 630). If so, selected media object is not recommended and the next media object, if any, is selected. If not, the selected media object is recommended (step 635) and the value of N is incremented by 1 (step 640).

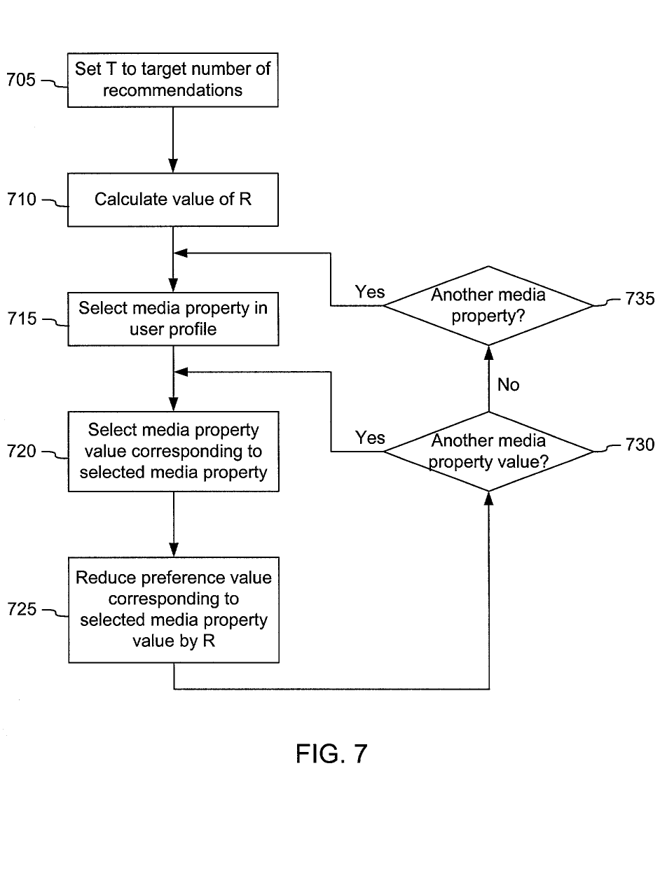

Returning to FIG. 2, after the media object has been recommended, the user profile is modified (step 260). FIG. 7 is a flow diagram for modifying a user profile consistent with the present invention. As shown in FIG. 7, a value T is calculated according to the target number of recommendations for the user (step 705). Using the value T, a value for R is calculated by dividing 100 by T (step 710). For example, if T=5, then R would equal 20.

Referring to the user profile, a media property in the user profile is selected (step 715). For example, the media property may be sub-genre. A media property value for the selected media property is then selected from the recommended media object (step 720). The media property value of the recommended media object may be Hard Rock. The percentage associated with the media property value in the user profile, which corresponds to the media property value selected from the recommended media object, is reduced by the value R (step 725). This reduction is then repeated for any other media property values in the recommended media object that correspond to the selected media property of the user profile (step 730). The process is also repeated for the other media properties of the user profile (step 735).

In another aspect of the present invention, a “sounds like” algorithm may be used to recommend a media object. This algorithm works by taking as input a media object (song, radio station, etc. . . . ), and finding up to N other media objects that match particular properties of the input object. The list of property types to match depends on the type of media.

In the sounds like algorithm, a vector is created of property types to match, based on the media type. If the media type is songs, then all of the property types are matched. However, if the media type is radio, then a subset of the property types, such as the sub-format and era, may be matched.

At the beginning of the process, the pool of media objects is randomly shuffled. Then, for each media object in the pool, if the current media object is the input object, i.e., the media object being compared against the media objects in the database of media objects, then the process moves to the next media object in the pool. If the current media object is not the input object, it is determined if each property (listed in the vector) matches. If the current media object does not have the same properties, then the next object in the pool is selected. However, if all of the properties (listed in the vector) match, then the current media object is selected as one which sounds like the input object. The process continues until all of the media objects in the pool are compared or until a set number of media objects have been selected as ones which sound like the input object.

What is claimed is:

1. A method for generating a recommendation to a user for a media object from a plurality of media objects located in a media object database stored in a memory, wherein each media object includes a plurality of properties, each property having one or more values, the method comprising:
filtering the plurality of media objects into a filtered pool of media objects based on a user profile corresponding to the user;
selecting a plurality of target property values based on the user profile;
generating a score for each of the media objects in the filtered pool based on the selected target property values; and
recommending a media object to the user from the media objects in the filtered pool based on the scores generated for each of the media objects in the filtered pool.

2. A method according to claim 1, further comprising modifying the user profile based on the media object recommended to the user.

3. A method according to claim 2, wherein the user profile includes a preference value for each of the plurality of target property values of the recommended media object and wherein the modifying includes adjusting each preference value of the user profile based on each of the plurality of target property values of the recommended media object.

4. A method according to claim 1, wherein the number of media objects in the filtered pool is less than the number of media objects in the media object database.

5. A method according to claim 1, wherein each media object is any one of a song, an album, a music video, a movie, a radio station, a TV station, a TV show, a book, and a video game.

6. A method according to claim 1, further comprising:
identifying each preference value in the user profile that has a zero value; and
excluding a media object from the filtered pool of media objects if the media object has a media property value corresponding to an identified preference value having a zero value.

7. A method according to claim 1, wherein the user profile includes a preference value for each possible property value of a media object.

8. A method according to claim 1, further comprising:
selecting a property in the user profile;
calculating a total of the preference values of each property value in the user profile;
generating a random number between zero and the calculated total; and
selecting a target property value for the selected property based on the random number.

9. A method according to claim 1, further comprising:
determining if a media object from the filtered pool of media objects has a selected target property value; and
increasing a score for the media object if the media object is determined to have the selected target property value.

10. A method according to claim 9, further comprising
selecting an alternative target property value if the media object is determine not to have the selected property value; and
increasing the score for the media object if the media object is determined to have the selected alternative target property value,
wherein the increase in the score for the media object is greater if the media object is determined to have the selected target property value as compared to if the media object is determined to have the alternative selected target property value.

11. A method according to claim 10, wherein the increase in score for the media object is adjusted with a weighting factor, and wherein a greatest weighting factor is used if the media object has the selected target property value.

12. A method according to claim 1, further comprising:
ordering the media objects from the filtered pool of media objects according to the generated scores;
selecting a media object according to the order;
determining if the selected media object satisfies one or more minimum separation rules; and
recommending the selected media object if it satisfies the one or more minimum separation rules.

13. A method according to claim 12, wherein the a first one of the one or more minimum separation rules determines if the selected media object has already been recommended to the user in less than a predetermined number of recommendations identified in the user profile.

14. A method according to claim 1, further comprising:
providing one or more questions to the user;
receiving responses to each of the questions provided to the user; and
modifying the user profile based on the received responses,
wherein at least one of the questions provided to the user is indirectly related to the media preferences of the user.

15. A computer system for generating a recommendation to a user for a media object from a plurality of media objects located in a media object database stored in a memory, wherein each media object includes a plurality of properties, each property having one or more values, the computer system comprising:
a processor; and
a memory comprising a plurality of instructions executed by the processor, the plurality of instructions configured to:
filter the plurality of media objects into a filtered pool of media objects based on a user profile corresponding to the user;
select a plurality of target property values based on the user profile;
generate a score for each of the media objects in the filtered pool based on the selected target property values; and
recommend a media object to the user from the media objects in the filtered pool based on the scores generated for each of the media objects in the filtered pool.

16. A computer system according to claim 15, the memory further comprising an instruction configured to modify the user profile based on the media object recommended to the user.

17. A computer system according to claim 16, wherein the user profile includes a preference value for each of the plurality of target property values of the recommended media object, the memory further comprising an instruction configured to adjust each preference value of the user profile based on each of the plurality of target property values of the recommended media object.

18. A computer system according to claim 15, wherein the number of media objects in the filtered pool is less than the number of media objects in the media object database.

19. A computer system according to claim 15, wherein each media object is any one of a song, an album, a music video, a movie, a radio station, a TV station, a TV show, a book, and a video game.

20. A computer system according to claim 15, the memory further comprising instructions configured to:
identify each preference value in the user profile that has a zero value; and
exclude a media object from the filtered pool of media objects if the media object has a media property value corresponding to an identified preference value having a zero value.

21. A computer system according to claim 15, wherein the user profile includes a preference value for each possible property value of a media object.

22. A computer system according to claim 15, the memory further comprising instructions configured to:
select a property in the user profile;
calculate a total of the preference values of each property value in the user profile;
generate a random number between zero and the calculated total; and
select a target property value for the selected property based on the random number.

23. A computer system according to claim 15, the memory further comprising instructions configured to:
determine if a media object from the filtered pool of media objects has a selected target property value; and
increase a score for the media object if the media object is determined to have the selected target property value.

24. A computer system according to claim 23, the memory further comprising instructions configured to:
select an alternative target property value if the media object is determine not to have the selected property value; and
increase the score for the media object if the media object is determined to have the selected alternative target property value,
wherein the increase in the score for the media object is greater if the media object is determined to have the selected target property value as compared to if the media object is determined to have the alternative selected target property value.

25. A computer system according to claim 24, wherein the increase in score for the media object is adjusted with a weighting factor, and wherein a greatest weighting factor is used if the media object has the selected target property value.

26. A computer system according to claim 15, the memory further comprising instructions configured to:
order the media objects from the filtered pool of media objects according to the generated scores;
select a media object according to the order;
determine if the selected media object satisfies one or more minimum separation rules; and
recommend the selected media object if it satisfies the one or more minimum separation rules.

27. A computer system according to claim 26, wherein the a first one of the one or more minimum separation rules determines if the selected media object has already been recommended to the user in less than a predetermined number of recommendations identified in the user profile.

28. A computer system according to claim 15, the memory further comprising instructions configured to:
provide one or more questions to the user;
receive responses to each of the questions provided to the user; and
modify the user profile based on the received responses,
wherein at least one of the questions provided to the user is indirectly related to the media preferences of the user.

29. A computer readable medium operable on a computer system configured to generate a recommendation to a user for a media object from a plurality of media objects located in a media object database stored in a memory, wherein each media object includes a plurality of properties, each property having one or more values, the computer readable medium configured to:
filter the plurality of media objects into a filtered pool of media objects based on a user profile corresponding to the user;
select a plurality of target property values based on the user profile;
generate a score for each of the media objects in the filtered pool based on the selected target property values; and
recommend a media object to the user from the media objects in the filtered pool based on the scores generated for each of the media objects in the filtered pool.

30. A computer readable medium according to claim 29, the computer readable medium further configured to modify the user profile based on the media object recommended to the user.

31. A computer readable medium according to claim 30, wherein the user profile includes a preference value for each of the plurality of target property values of the recommended media object, the computer readable medium further configured to adjust each preference value of the user profile based on each of the plurality of target property values of the recommended media object.

32. A computer readable medium according to claim 29, wherein the number of media objects in the filtered pool is less than the number of media objects in the media object database.

33. A computer readable medium according to claim 29, wherein each media object is any one of a song, an album, a music video, a movie, a radio station, a TV station, a TV show, a book, and a video game.

34. A computer readable medium according to claim 29, the computer readable medium further configured to:
identify each preference value in the user profile that has a zero value; and
exclude a media object from the filtered pool of media objects if the media object has a media property value corresponding to an identified preference value having a zero value.

35. A computer readable medium according to claim 29, wherein the user profile includes a preference value for each possible property value of a media object.

36. A computer readable medium according to claim 29, the computer readable medium further configured to:
select a property in the user profile;
calculate a total of the preference values of each property value in the user profile;
generate a random number between zero and the calculated total; and
select a target property value for the selected property based on the random number.

37. A computer readable medium according to claim 29, the computer readable medium further configured to:
determine if a media object from the filtered pool of media objects has a selected target property value; and
increase a score for the media object if the media object is determined to have the selected target property value.

38. A computer readable medium according to claim 37, the computer readable medium further configured to:
select an alternative target property value if the media object is determine not to have the selected property value; and
increase the score for the media object if the media object is determined to have the selected alternative target property value,
wherein the increase in the score for the media object is greater if the media object is determined to have the selected target property value as compared to if the media object is determined to have the alternative selected target property value.

39. A computer readable medium according to claim 38, wherein the increase in score for the media object is adjusted with a weighting factor, and wherein a greatest weighting factor is used if the media object has the selected target property value.

40. A computer readable medium according to claim 29, the computer readable medium further configured to:
order the media objects from the filtered pool of media objects according to the generated scores;
select a media object according to the order;
determine if the selected media object satisfies one or more minimum separation rules; and
recommend the selected media object if it satisfies the one or more minimum separation rules.

41. A computer readable medium according to claim 40, wherein the a first one of the one or more minimum separation rules determines if the selected media object has already been recommended to the user in less than a predetermined number of recommendations identified in the user profile.

42. A computer readable medium according to claim 29, the computer readable medium further configured to:
provide one or more questions to the user;
receive responses to each of the questions provided to the user; and
modify the user profile based on the received responses,
wherein at least one of the questions provided to the user is indirectly related to the media preferences of the user.
